(19) United States
(12) Patent Application Publication
(10) Pub. No.: US 2026/0074218 A1
(43) Pub. Date: Mar. 12, 2026

(54) POSITIVE ELECTRODE ACTIVE MATERIAL FOR LITHIUM-ION SECONDARY BATTERY AND LITHIUM-ION SECONDARY BATTERY

(71) Applicants: HONDA MOTOR CO., LTD., Tokyo (JP); Kansai Catalyst Co., Ltd., Osaka (JP); FORMOSA JAPAN Co., Ltd., Tokyo (JP)

(72) Inventors: Kazumasa SAKATSUME, Saitama (JP); Takashi HAKARI, Saitama (JP); Kazuki CHIBA, Saitama (JP); Akihisa TANAKA, Saitama (JP); Yoshiyuki MORITA, Saitama (JP); Koichi HASHIMOTO, Osaka (JP); Toshiyuki TODA, Tokyo (JP)

(21) Appl. No.: 19/324,472

(22) Filed: Sep. 10, 2025

(30) Foreign Application Priority Data
Sep. 12, 2024 (JP) 2024-158184

(51) Int. Cl. H01M 4/525; C01G 53/42; C01G 53/84; H01M 10/0525

(52) U.S. Cl. CPC H01M 4/525; C01G 53/42; C01G 53/84; H01M 10/0525; C01P 2002/72; C01P 2002/74; C01P 2002/76; C01P 2004/61; C01P 2006/40

(57) ABSTRACT

A positive electrode active material for a lithium-ion secondary battery, containing, as a main component, a lithium transition metal composite oxide that is in a form of a particle having an outer layer on a surface thereof, and is represented by:

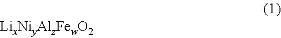

where 0.95≤x≤1.05, 0.78≤y≤0.95, 0.01≤z≤0.15, and 0.01≤w≤0.15, and x+y+z+w=2,
a ratio between a ratio of the number of atoms of Fe to that of Ni in the outer layer and a ratio of the number of atoms of Fe to that of Ni in the entire particle is 0.7 to 1.7, inclusive and
a ratio (I₁/I₂) between integrated intensities (I₁) and (I₂) of diffraction peaks of a 003 plane and a 104 plane, respectively, in a space group R-3m is 1.15 to 1.35, inclusive.

### BACKGROUND

### Technical Field

The present invention relates to a positive electrode active material for a lithium-ion secondary battery and a lithium-ion secondary battery.

### Related Art

In recent years, research and development on a secondary battery that contributes to improvement of energy efficiency have been conducted. In particular, a lithium-ion secondary battery is becoming increasingly important as a power source for an electric vehicle (EV), a hybrid electric vehicle (HEV), or the like.

A positive electrode active material has attracted attention as an important component for determining a capacity of a lithium-ion secondary battery, and development thereof has been advanced. As a positive electrode active material used for a lithium-ion secondary battery, a material based on cobalt has been conventionally used.

However, a material based on cobalt is expensive and has been pointed out to be a resource risk. Therefore, development of a material based on an element instead of cobalt is required. For example, Nitin Muralidharan, et al., “LiNiₓFe_{y}Al_{z}O₂, A New Cobalt-Free Layered Cathode Material For Advanced Li-ion Batteries” Journal of Power Sources. Volume 471, 228389, 30 Sep. 2020 reports, as a cobalt-free material, a positive electrode active material in which nickel, iron, and aluminum are converted into a hydroxide by a coprecipitation process.

### CITATION LIST

### Non Patent Literature

Non Patent Literature 1: Nitin Muralidharan, et al., “LiNiₓFe_{y}Al_{z}O₂, A New Cobalt-Free Layered Cathode Material For Advanced Li-ion Batteries” Journal of Power Sources. Volume 471, 228389, 30 Sep. 2020

### SUMMARY

Nitin Muralidharan, et al., “LiNiₓFe_{y}Al_{z}O₂, A New Cobalt-Free Layered Cathode Material For Advanced Li-ion Batteries” Journal of Power Sources. Volume 471, 228389, 30 Sep. 2020 reports that a lithium-ion secondary battery prepared using a positive electrode active material has achieved a high capacity of 190 mAh/g at a rate of 0.1 C.

However, there is still room for improvement in a capacity of the lithium-ion secondary battery.

The present invention has been made to solve the above problems, and an object of the present invention is to provide a cobalt-free positive electrode active material for a lithium-ion secondary battery, from which a lithium-ion secondary battery capable of further increasing a discharge capacity can be obtained, and a lithium-ion secondary battery using the positive electrode active material. This ultimately contributes to improvement of energy efficiency.

In order to achieve the above object, the present invention provides the following configurations.
[1] A positive electrode active material for a lithium-ion secondary battery, containing a lithium transition metal composite oxide as a main component, wherein
   the lithium transition metal composite oxide is in a form of a particle having an outer layer on a surface thereof,
   the lithium transition metal composite oxide is represented by the following formula (1):

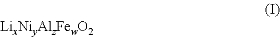

(In formula (1), x, y, z, and w are in ranges of 0.95≤x≤1.05, 0.78≤y≤0.95, 0.01≤z≤0.15, and 0.01≤w≤0.15, respectively, and x+y+z+w=2 is satisfied.),
a ratio between a ratio of the number of atoms of Fe to the number of atoms of Ni in the outer layer and a ratio of the number of atoms of Fe to the number of atoms of Ni in the entire particle is 0.7 or more and 1.7 or less, and
a ratio (I₁/I₂) of an integrated intensity (I₁) of a diffraction peak of a 003 plane to an integrated intensity (I₂) of a diffraction peak of a 104 plane in a space group R-3m measured by X-ray diffraction is 1.15 or more and 1.35 or less.

In the positive electrode active material for a lithium-ion secondary battery (hereinafter, also simply referred to as a “positive electrode active material”) according to [1], the ratio between a ratio (Fe/Ni ratio) of the number of atoms of Fe to the number of atoms of Ni in the outer layer and a ratio (Fe/Ni ratio) of the number of atoms of Fe to the number of atoms of Ni in the entire particle (hereinafter, also referred to as “Fe/Ni ratio in ‘outer layer/entire particle’”) is within a specific range. Therefore, the Fe/Ni ratio in ‘outer layer/entire particle’ is uniform, and inhibition of movement of lithium ions is suppressed. In addition, in the positive electrode active material according to [1], since the integrated intensity ratio (I₁/I₂) is within a specific value range, mixing between a layer of a lithium metal and a layer of a transition metal is reduced (cation mixing is reduced), and lithium ions are easily diffused. Therefore, a discharge capacity of a lithium-ion secondary battery (hereinafter, also simply referred to as a “secondary battery”) can be further increased. Therefore, in the secondary battery using the positive electrode active material, the number of batteries required can be reduced, which can contribute to cost reduction. That is, it is possible to contribute to improvement of energy efficiency.
[2] The positive electrode active material for a lithium-ion secondary battery according to [1], wherein among lattice constants of the lithium transition metal composite oxide in the space group R-3m, an a-axis length is 2.860 Å to 2.890 Å and a c-axis length is 14.18 Å to 14.28 Å.

In the positive electrode active material according to [2], among lattice constants, the a-axis length and the c-axis length are within specific ranges. Therefore, lithium ions are easily diffused in a primary particle, and resistance can be reduced. Therefore, a discharge capacity of the secondary battery can be further increased. Therefore, it is possible to contribute to further improvement of energy efficiency.
[3] The positive electrode active material for a lithium-ion secondary battery according to [1] or [2], wherein particles of the lithium transition metal composite oxide have an average particle size of 2 to 30 μm.

The positive electrode active material according to [3] has a specific average particle size. Therefore, an electrochemical characteristic of the secondary battery can be further improved. Therefore, it is possible to contribute to further improvement of energy efficiency.
[4] A lithium-ion secondary battery including: a positive electrode; a negative electrode; and an electrolyte, wherein the positive electrode contains the positive electrode active material for a lithium-ion secondary battery according to any one of [1] to [3].

In the secondary battery according to [4], the positive electrode contains the positive electrode active material. Therefore, the discharge capacity can be further increased, the number of batteries required can be reduced, which can contribute to cost reduction. That is, it is possible to contribute to improvement of energy efficiency.

The positive electrode active material for a lithium-ion secondary battery and the lithium-ion secondary battery according to the present invention can further increase a discharge capacity.

### BRIEF DESCRIPTION OF DRAWINGS

FIG. 1 is a cross-sectional view schematically illustrating a lithium-ion secondary battery prepared in Examples;

FIG. 2 is a diagram illustrating an X-ray diffraction (XRD) pattern of a positive electrode active material of Example 1;

FIG. 3 is a diagram illustrating an XRD pattern of a positive electrode active material of Example 2;

FIG. 4 is a diagram illustrating an XRD pattern of a positive electrode active material of Comparative Example 1;

FIG. 5 is a diagram illustrating an XRD pattern of a positive electrode active material of Comparative Example 2;

FIG. 6 is a diagram illustrating an XRD pattern of a positive electrode active material of Example 3;

FIG. 7 is a diagram illustrating an XRD pattern of a positive electrode active material of Comparative Example 3;

FIG. 8 is a diagram illustrating an XRD pattern of a positive electrode active material of Comparative Example 4;

FIG. 9 is a diagram illustrating an XRD pattern of a positive electrode active material of Comparative Example 5;

FIG. 10 is a diagram illustrating a discharge curve of a lithium-ion secondary battery of Example 1;

FIG. 11 is a diagram illustrating a discharge curve of a lithium-ion secondary battery of Example 2;

FIG. 12 is a diagram illustrating a discharge curve of a lithium-ion secondary battery of Comparative Example 1;

FIG. 13 is a diagram illustrating a discharge curve of a lithium-ion secondary battery of Comparative Example 2;

FIG. 14 is a diagram illustrating a discharge curve of a lithium-ion secondary battery of Example 3;

FIG. 15 is a diagram illustrating a discharge curve of a lithium-ion secondary battery of Comparative Example 3;

FIG. 16 is a diagram illustrating a discharge curve of a lithium-ion secondary battery of Comparative Example 4; and

FIG. 17 is a diagram illustrating a discharge curve of a lithium-ion secondary battery of Comparative Example 5.

### DETAILED DESCRIPTION

Hereinafter, a preferred embodiment of the present invention will be described in detail.

### [Positive Electrode Active Material for Lithium-Ion Secondary Battery]

A positive electrode active material for a lithium-ion secondary battery (hereinafter, also simply referred to as a “positive electrode active material”) of the present embodiment contains a lithium transition metal composite oxide as a main component, and is used for a positive electrode of a lithium-ion secondary battery (hereinafter, also simply referred to as a “secondary battery”). The phrase “contains a lithium transition metal composite oxide as a main component” means that the content of the lithium transition metal composite oxide is 75% by mass or more, preferably 80% by mass or more, more preferably 90% by mass or more, and still more preferably 95% by mass or more with respect to the total mass of the positive electrode active material, and may be 100% by mass. The positive electrode active material may contain a component other than the main component as long as a function of the present invention is not impaired.

The positive electrode active material of the present embodiment may contain only one type or two or more types of lithium transition metal composite oxides as long as the lithium transition metal composite oxide is contained as a main component.

When the positive electrode active material is produced by using the lithium transition metal composite oxide as a main component, a composition ratio (Li:Ni:Al:Fe) of the entire lithium transition metal composite oxide is also maintained in an obtained positive electrode active material. When a positive electrode active material obtained by using the lithium transition metal composite oxide having such a composition as a main component is used in a secondary battery, a high capacity can be achieved. In addition, the composition ratio of the lithium transition metal composite oxide is adjusted so as to be similar to a composition ratio required for a positive electrode active material to be obtained.

(Lithium transition metal composite oxide)

The lithium transition metal composite oxide of the present embodiment is a layered rock salt type oxide and is in a form of a particle having an outer layer on a surface thereof.

In the present specification, an average particle size of particles of the lithium transition metal composite oxide is not particularly limited, but is, for example, preferably 2 to 30 μm, more preferably 3 to 20 μm, and still more preferably 5 to 15 μm. When the average particle size of particles of the lithium transition metal composite oxide is the above lower limit value or more, productivity of the positive electrode active material can be further enhanced. When the average particle size of particles of the lithium transition metal composite oxide is the above upper limit value or less, an electrochemical characteristic of the secondary battery can be further improved.

The average particle size of particles of the lithium transition metal composite oxide means, for example, D50 measured by a laser diffraction particle size distribution measuring apparatus or the like.

### <Chemical Composition>

The lithium transition metal composite oxide of the present embodiment is represented by the following formula (1).

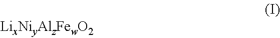

In formula (1), x, y, z, and w are in ranges of 0.95≤x≤1.05, 0.78≤y≤0.95, 0.01≤z≤0.15, and 0.01≤w≤0.15, respectively, and x+y+z+w=2 is satisfied.

In the lithium transition metal composite oxide of the present embodiment, x, y, z, and w are more preferably in ranges of 0.97≤x≤1.03, 0.80≤y≤0.92, 0.04≤z≤0.09, and 0.04≤w≤0.12, respectively in formula (1).

A chemical composition of the lithium transition metal composite oxide of the present embodiment can be determined by inductively coupled plasma (ICP) emission spectral analysis.

### <Surface Composition>

The particle of the lithium transition metal composite oxide has an outer layer on a surface thereof.

In the present specification, the “outer layer” refers to a region up to 25 nm from a surface of a particle toward the inside of the particle. Note that when a particle size is less than 50 nm, the particle has a single layer structure composed only of an outer layer.

In the particles of the lithium transition metal composite oxide of the present embodiment, a ratio between a ratio of the number of atoms of Fe to the number of atoms of Ni in the outer layer (Fe/Ni ratio) and a Fe/Ni ratio in the entire particle (hereinafter, also referred to as “Fe/Ni ratio in ‘outer layer/entire particle’”) is preferably uniform.

More specifically, the Fe/Ni ratio in ‘outer layer/entire particle’ is 0.7 or more and 1.7 or less, preferably 0.9 or more and 1.5 or less, and more preferably 1.1 or more and 1.3 or less. When the Fe/Ni ratio in ‘outer layer/entire particle’ is within the above numerical range, movement of lithium ions is not inhibited, and a charge and discharge capacity of a secondary battery can be further increased when the particles of the lithium transition metal composite oxide are used as a positive electrode active material.

The Fe/Ni ratio can be determined by quantitative analysis of X-ray photoelectron spectroscopy (XPS). According to XPS, a composition of a transition metal element in the entire particle can be analyzed. That is, an analysis result obtained by XPS does not indicate a local composition of the entire surface of one particle, but indicates a composition of the entire surface of the particle.

The particle of the lithium transition metal composite oxide of the present embodiment may be a primary particle or a secondary particle. The particle of the lithium transition metal composite oxide is preferably a secondary particle in which a plurality of primary particles are aggregated with each other from a viewpoint that relatively dense particles can be obtained.

### <Lattice Constant>

The lithium transition metal composite oxide of the present embodiment is a rhombohedral layered compound, and has a crystal structure of a space group R-3m. With regard to a lattice constant of the positive electrode active material of the present embodiment containing the lithium transition metal composite oxide as a main component, an a-axis length is preferably 2.860 Å to 2.890 Å, and a c-axis length is preferably 14.18 Å to 14.28 Å. With the lattice constant within the above range, in the positive electrode active material, lithium ions are easily diffused in a primary particle, and the positive electrode active material has low resistance.

A lattice constant of a crystal can be determined by a least square method by measuring an X-ray diffraction pattern of the positive electrode active material and using each index and a plane spacing thereof.

### <X-Ray Diffraction (XRD) Pattern>

In the positive electrode active material of the present embodiment, a ratio (I₁/I₂) of an integrated intensity (I₁) of a diffraction peak of a 003 plane to an integrated intensity (I₂) of a diffraction peak of a 104 plane in a space group R-3m measured by X-ray diffraction (XRD) is 1.15 or more and 1.35 or less, preferably 1.20 or more and 1.30 or less, and more preferably 1.23 or more and 1.27 or less. With the integrated intensity ratio (I₁/I₂) within the above numerical range, cation mixing is reduced, and lithium ions are easily diffused. Therefore, the discharge capacity of the secondary battery can be further increased.

The integrated intensity ratio (I₁/I₂) is determined by analyzing an XRD pattern.

### [Method for Producing Positive Electrode Active Material]

The positive electrode active material of the present embodiment contains the above-described lithium transition metal composite oxide as a main component. As a lithium source of the lithium transition metal composite oxide, it is possible to use a known compound such as a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O), and there is no particular limitation. As compounds of a nickel source, an aluminum source, and an iron source which are transition metals, known oxides, hydroxides, or metal salts of nickel, aluminum, and iron can be widely used, and are not particularly limited.

For example, as the nickel compound, nickel hydroxide (Ni(OH)₂), nickel(II) chloride (NiCl₂), nickel(II) chloride hexahydrate (NiCl₂·6H₂O), and nickel(II) nitrate hexahydrate (Ni(NO₃)₂·6H₂O) can be used, but the nickel compound is not limited thereto.

As the aluminum compound, aluminum chloride (AlCl₃), aluminum carbonate (Al₂(CO₃)₃), aluminum nitrate nonahydrate (Al(NO₃)₃·9H₂O), and the like can be used, but the aluminum compound is not limited thereto.

As the iron compound, iron(II) sulfate (Fe(SO₄)), iron(II) hydroxide (Fe(OH)₂), and the like can be used, but the iron compound is not limited thereto.

The transition metal compounds can be used singly or as a composite hydroxide (for example, nickel-aluminum-iron composite hydroxide) or the like by using a coprecipitation method or the like.

The lithium transition metal composite oxide of the present embodiment can be synthesized by using a known method. For example, a composite hydroxide or a composite oxide of a nickel compound and an aluminum compound is prepared as an intermediate compound, the intermediate compound, an iron compound, and a lithium compound are mixed to obtain a raw material mixture (mixing step), and the raw material mixture is heat-treated (for example, fired) at a predetermined temperature for a predetermined time in a predetermined atmosphere, whereby the lithium transition metal composite oxide can be synthesized (heat treatment step). Alternatively, a composite hydroxide or a composite oxide of a nickel compound, an aluminum compound, and an iron compound is prepared as an intermediate compound, the intermediate compound and a lithium compound are mixed to obtain a raw material mixture, and the raw material mixture is heat-treated (for example, fired) at a predetermined temperature for a predetermined time in a predetermined atmosphere, whereby the lithium transition metal composite oxide can be synthesized.

The present inventors have found that the integrated intensity ratio (I₁/I₂) of the positive electrode active material can be controlled within a specific numerical range by appropriately selecting the above heat treatment conditions. With the integrated intensity ratio (I₁/I₂) of the positive electrode active material within a specific numerical range, the transition metals of the lithium transition metal composite oxide are uniformly dispersed, cation mixing is reduced, and lithium ions are easily diffused. Therefore, the discharge capacity of the secondary battery can be further increased.

Hereinafter, a method for producing the positive electrode active material of the present embodiment will be described for each step.

### <Mixing Step>

A mixing step is a step of mixing a lithium compound and the above-described intermediate compound to obtain a raw material mixture.

The lithium compound is not particularly limited, but examples thereof include a hydroxide such as lithium hydroxide monohydrate (LiOH·H₂O), a carbonate such as lithium carbonate (Li₂CO₃), and an acetate such as lithium acetate (CH₃COOLi) or lithium acetate dihydrate (CH₃COOLi·2H₂O).

These lithium compounds may be used singly or in combination of two or more types thereof.

A known mixer can be used for mixing the lithium compound and the intermediate compound.

Examples of such a mixer include a shaker mixer, a Loedige mixer, a Julia mixer, and a V blender.

Mixing conditions in the mixing step are not particularly limited, but it is preferable to select conditions such that components serving as raw materials are sufficiently mixed to an extent that the shapes of particles and the like of the raw materials such as the intermediate compound are not broken.

A particle size or the like of each of the lithium compound and the intermediate compound is preferably adjusted in advance such that a desired lithium transition metal composite oxide can be obtained after the heat treatment step.

The lithium compound and the intermediate compound are preferably mixed by weighing lithium, nickel, aluminum, and iron in the raw material mixture after mixing such that a ratio among the amounts of substances in the lithium transition metal composite oxide is Li:Ni:Al:Fe=x:y:z:w after the heat treatment step. More specifically, the lithium compound is weighed more than a stoichiometric ratio by 1% by mass to 5% by mass, preferably about 1 to 3% by mass.

Here, x, y, z, and w can be in the same ranges as those described for the lithium transition metal composite oxide in the positive electrode active material.

### <Heat Treatment Step>

The heat treatment step is a step of heat-treating the raw material mixture obtained in the mixing step at a predetermined temperature for a predetermined time in a predetermined atmosphere.

In the heat treatment step, the raw material mixture is filled into a crucible or the like, and the mixture is heat-treated. As the crucible, for example, an alumina sagger, an alumina crucible, a platinum crucible, or a gold crucible is used. In the heat treatment of the raw material mixture, for example, a firing furnace or a roller hearth kiln is used.

The raw material mixture put in a sagger or a crucible is heated at a temperature-rising rate of 5° C./min to 25° C./min, preferably 10° C./min to 25° C./min such that the temperature reaches a heat treatment temperature. A heat treatment atmosphere is not particularly limited, and examples thereof include the atmosphere (under an air atmosphere) and an oxygen flow. The heat treatment atmosphere is preferably an oxygen flow. A heat treatment time can be appropriately set according to a heat treatment temperature. Note that the heat treatment time means time for holding the heat treatment temperature.

The heat treatment temperature is preferably 700° C. or higher and 800° C. or lower, and more preferably 720° C. or higher and 780° C. or lower. The heat treatment time is preferably six hours or more and 18 hours or less, and more preferably eight hours or more and 15 hours or less.

The method for producing a positive electrode active material according to the present embodiment may include a step other than the mixing step and the heat treatment step.

Examples of such a step include a cooling step.

### <Cooling Step>

The cooling step is a step of cooling the lithium transition metal composite oxide obtained in the heat treatment step to a predetermined temperature at a predetermined temperature-lowering rate.

In the cooling step, for example, the powder obtained in the heat treatment step is cooled at a temperature-lowering rate of 5° C./min to 25° C./min, preferably 10° C./min to 25° C./min until the temperature reaches room temperature (for example, 25° C.). An atmosphere for cooling the powder is not particularly limited, and examples thereof include an atmosphere (under an air atmosphere), an air flow, and an oxygen flow.

In the positive electrode active material of the present embodiment, by appropriately selecting the heat treatment temperature and the heat treatment time in the heat treatment step, the Fe/Ni ratio in ‘outer layer/entire particle’ of the lithium transition metal composite oxide can be more easily adjusted to a specific range.

### [Lithium-Ion Secondary Battery]

The lithium-ion secondary battery (hereinafter, also simply referred to as a “secondary battery”) of the present embodiment includes a positive electrode, a negative electrode, and an electrolyte, and the positive electrode contains a positive electrode active material containing the above-described lithium transition metal composite oxide as a main component. The secondary battery of the present embodiment may include another battery element as necessary.

In the secondary battery of the present embodiment, a battery element of a known lithium-ion secondary battery can be adopted as it is except that the positive electrode contains a positive electrode active material containing the above-described lithium transition metal composite oxide as a main component. The secondary battery of the present embodiment may have any of coin type, button type, cylindrical type, square type, and laminate type configurations. In addition, the secondary battery of the present embodiment is applicable to a wide range of applications such as a mobile device such as a mobile phone or a laptop computer and an in-vehicle application.

Hereinafter, with respect to the secondary battery of the present embodiment, a secondary battery (coin-type lithium-ion secondary battery) using an electrolytic solution will be described. Each battery element described below can be similarly applied to an all-solid-state lithium-ion secondary battery not using an electrolytic solution.

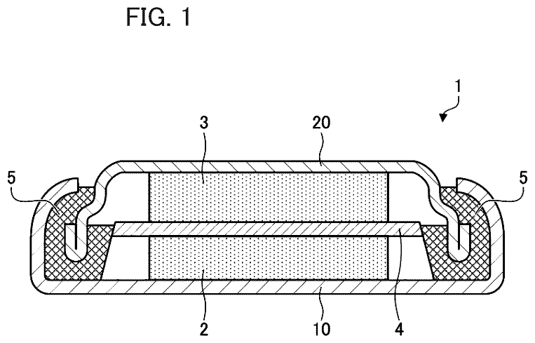

FIG. 1 is a cross-sectional view schematically illustrating the lithium-ion secondary battery according to the present embodiment. FIG. 1 illustrates an example in which the lithium-ion secondary battery of the present embodiment is a coin-type lithium-ion secondary battery. As illustrated in FIG. 1, a lithium-ion secondary battery 1 of the present embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed on a lower side of the separator 4, the negative electrode can 20 is disposed on an upper side of the separator 4, and an outer shape of the lithium-ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium-ion secondary battery 1, the positive electrode 2 can be prepared by blending a conductive agent, a binder, and the like with the positive electrode active material of the present embodiment as necessary to prepare a positive electrode mixture, and pressing the positive electrode mixture to a current collector (not illustrated).

As the current collector, a stainless steel mesh, aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the conductive agent in the positive electrode mixture is preferably 18 by mass to 15% by mass, and more preferably 0.1% by mass to 5% by mass. The content of the binder in the positive electrode mixture is preferably 0.1% by mass to 10% by mass, and more preferably 0.1% by mass to 5% by mass. It is preferable to blend the positive electrode active material, the conductive agent, and the binder such that a remainder (a portion other than the binder and the conductive agent) in the positive electrode mixture is the positive electrode active material.

In the lithium-ion secondary battery 1, as the negative electrode 3 with respect to the positive electrode 2, a known electrode that functions as a negative electrode active material and can intercalate and release lithium, for example, a metal-based material such as metallic lithium or a lithium alloy, a carbon-based material such as graphite or mesocarbon microbeads (MCMB), or a silicon-based material such as silicon (Si), a Si alloy, or silicon oxide can be adopted.

Known battery elements can be adopted as the separator 4 and the battery containers (positive electrode can 10 and negative electrode can 20).

As the electrolyte, a known electrolytic solution, a known solid electrolyte, or the like can be adopted. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In addition, the all-solid-state lithium-ion secondary battery can have a similar structure to that of a known all-solid-state lithium-ion secondary battery except that a positive electrode active material containing the above-described lithium transition metal composite oxide as a main component is used.

In the case of the all-solid-state lithium-ion secondary battery, as the electrolyte, for example, a solid electrolyte such as a polymer-based solid electrolyte such as a polyethylene oxide-based polymer compound or a polymer compound including at least one of a polyorganosiloxane chain and a polyoxyalkylene chain, a sulfide-based solid electrolyte, or an oxide-based solid electrolyte can be used.

As for a positive electrode of the all-solid-state lithium-ion secondary battery, for example, a positive electrode mixture containing a solid electrolyte in addition to the positive electrode active material, the conductive agent, and the binder described above can be carried on a positive electrode current collector such as aluminum, nickel, or stainless steel.

In the lithium-ion secondary battery 1 of the present embodiment, since the positive electrode 2 contains a positive electrode active material containing the above-described lithium transition metal composite oxide as a main component, a discharge capacity can be further increased.

### EXAMPLES

Hereinafter, Examples of the present invention will be described, but the present invention is not limited to Examples below.

### Example 1

### <Preparation of Nickel-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.10 (measured value at 50° C.).

While the liquid temperature in the beaker was maintained at 50° C. and the mixture in the beaker was stirred at a speed of 600 rpm, a solution adjusted so as to contain nickel sulfate and aluminum sulfate at a molar ratio (Ni:Al=95.3:4.7) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.10±0.05 (measured value at 50° C.).

Subsequently, the reaction was allowed to proceed while a liquid property of the reaction liquid was controlled, and a slurry discharged from the overflow tube during 30 hours to 50 hours after start of the reaction was dehydrated and washed with water to obtain a nickel-aluminum coprecipitated hydroxide.

### <Iron Hydroxide Coating Step>

In a 5 L beaker, 955 g (solid content weight) of the obtained nickel-aluminum coprecipitated hydroxide powder was put, and adjusted so as to obtain a 20% by weight slurry liquid with water, and the liquid was heated to 75° C. Furthermore, this slurry liquid was adjusted with a sulfuric acid aqueous solution or a sodium hydroxide aqueous solution so as to have a pH of 9.00±0.05 (measured value at 75° C.). In addition, in order to prevent oxidation of iron, purge with a certain amount of nitrogen gas was performed.

Next, while the temperature was maintained at 75° C. and the slurry liquid was stirred, an iron sulfate aqueous solution adjusted to 10% by weight in terms of metal was continuously added dropwise such that iron(II) hydroxide equivalent to 4.5 mol % of iron was precipitated on a surface of nickel hydroxide, and a 25% by mass sodium hydroxide aqueous solution was also added dropwise so as to maintain a pH of 9.00±0.05 (measured value at 75° C.).

As a result, a slurry of a nickel-aluminum hydroxide coated with iron hydroxide was obtained. Subsequently, the obtained slurry was dehydrated, washed with an alkali and washed with water, then dried at 110° C. for 10 hours, and then caused to pass through a 100 mesh sieve to obtain 1 kg of an intermediate compound in which a surface of the nickel-aluminum hydroxide was coated with iron hydroxide.

### <Preparation of Positive Electrode Active Material>

1.38 g of the obtained intermediate compound and 0.65 g of a lithium compound (LiOH·H₂O) were dispersed in ethanol in a mortar and mixed. Thereafter, the resulting mixture was filled in a JIS standard platinum crucible. The mixture filled in the platinum crucible was heated in air at a temperature-rising rate of 10° C./min and fired at 750° C. for 10 hours using a firing furnace, and then the obtained powder was left to stand until the temperature of the powder reached room temperature (25° C.) to obtain a positive electrode active material of Example 1 having a chemical composition presented in Table 1. In Table 1, “-” means that the element is not contained.

### Example 2

### <Preparation of Nickel-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.00 (measured value at 50° C.).

While the liquid temperature in the beaker was maintained at 50° C. and the mixture in the beaker was stirred at a speed of 600 rpm, a solution adjusted so as to contain nickel sulfate and aluminum sulfate at a molar ratio (Ni:Al=95.3:4.7) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.00±0.05 (measured value at 50° C.).

While a liquid property of the reaction liquid was controlled, a slurry concentration apparatus was connected and a solid-liquid separation operation was continuously performed. Only a filtrate was discharged to the outside of the system, and an operation of increasing a slurry concentration was performed in parallel. The slurry after completion of the reaction was dehydrated and washed with water to obtain a nickel-aluminum coprecipitated hydroxide.

### <Iron Hydroxide Coating Step>

In a 5 L beaker, 955 g (solid content weight) of the obtained nickel-aluminum coprecipitated hydroxide powder was put, and adjusted so as to obtain a 20% by weight slurry liquid with water, and the liquid was heated to 75° C. Furthermore, this slurry liquid was adjusted with a sulfuric acid aqueous solution or a sodium hydroxide aqueous solution so as to have a pH of 9.00±0.05 (measured value at 75° C.). In addition, in order to prevent oxidation of iron, purge with a certain amount of nitrogen gas was performed.

Next, while the temperature was maintained at 75° C. and the slurry liquid was stirred, an iron sulfate aqueous solution adjusted to 10% by weight in terms of metal was continuously added dropwise such that iron(II) hydroxide equivalent to 4.5 mol % of iron was precipitated on a surface of nickel hydroxide, and a 25% by mass sodium hydroxide aqueous solution was also added dropwise so as to maintain a pH of 9.00±0.05 (measured value at 75° C.).

As a result, a slurry of a nickel-aluminum hydroxide coated with iron hydroxide was obtained. Subsequently, the obtained slurry was dehydrated, washed with an alkali and washed with water, then dried at 110° C. for 10 hours, and then caused to pass through a 100 mesh sieve to obtain 1 kg of an intermediate compound in which a surface of the nickel-aluminum hydroxide was coated with iron hydroxide.

### <Preparation of Positive Electrode Active Material>

1.38 g of the obtained intermediate compound and 0.65 g of a lithium compound (LiOH·H₂O) were dispersed in ethanol in a mortar and mixed. Thereafter, the resulting mixture was filled in a JIS standard platinum crucible. The mixture filled in the platinum crucible was heated in air at a temperature-rising rate of 10° C./min and fired at 750° C. for 10 hours using a firing furnace, and then the obtained powder was left to stand until the temperature of the powder reached room temperature (25° C.) to obtain a positive electrode active material of Example 2 having a chemical composition presented in Table 1.

### Comparative Example 1

### <Preparation of Nickel-Aluminum-Iron Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.00 (measured value at 50° C.).

While the liquid temperature in the beaker was maintained at 50° C. and the mixture in the beaker was stirred at a speed of 600 rpm, a solution adjusted so as to contain nickel sulfate, aluminum sulfate, and iron(II) sulfate at a molar ratio (Ni:Al:Fe=91.0:4.5:4.5) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.00±0.05 (measured value at 50° C.).

While a liquid property of the reaction liquid was controlled, a slurry concentration apparatus was connected and a solid-liquid separation operation was continuously performed. Only a filtrate was discharged to the outside of the system, and an operation of increasing a slurry concentration was performed in parallel. The slurry after completion of the reaction was dehydrated and washed with water to obtain a nickel-aluminum coprecipitated hydroxide. The slurry after completion of the reaction was dehydrated, washed with an alkali and washed with water, then dried at 110° C. for 10 hours, and then caused to pass through a 100 mesh sieve to obtain a nickel-aluminum-iron coprecipitated hydroxide (intermediate compound).

### <Preparation of Positive Electrode Active Material>

1.38 g of the obtained intermediate compound and 0.65 g of a lithium compound (LiOH·H₂O) were dispersed in ethanol in a mortar and mixed. Thereafter, the resulting mixture was filled in a JIS standard platinum crucible. The mixture filled in the platinum crucible was heated in air at a temperature-rising rate of 10° C./min and fired at 750° C. for 10 hours using a firing furnace, and then the obtained powder was left to stand until the temperature of the powder reached room temperature (25° C.) to obtain a positive electrode active material of Comparative Example 1 having a chemical composition presented in Table 1.

### Comparative Example 2

### <Preparation of Nickel-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.10 (measured value at 50° C.).

While the liquid temperature in the beaker was maintained at 50° C. and the mixture in the beaker was stirred at a speed of 600 rpm, a solution adjusted so as to contain nickel sulfate and aluminum sulfate at a molar ratio (Ni:Al=95.3:4.7) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.10±0.05 (measured value at 50° C.).

Subsequently, the reaction was allowed to proceed while a liquid property of the reaction liquid was controlled, and a slurry discharged from the overflow tube during 30 hours to 50 hours after start of the reaction was dehydrated and washed with water to obtain a nickel-aluminum coprecipitated hydroxide.

### <Iron Hydroxide Coating Step>

In a 5 L beaker, 955 g (solid content weight) of the obtained nickel-aluminum coprecipitated hydroxide powder was put, and adjusted so as to obtain a 20% by weight slurry liquid with water, and the liquid was heated to 75° C. Furthermore, this slurry liquid was adjusted with a sulfuric acid aqueous solution or a sodium hydroxide aqueous solution so as to have a pH of 11.00±0.05 (measured value at 75° C.).

Next, while the temperature was maintained at 75° C. and the slurry liquid was stirred, an iron sulfate aqueous solution adjusted to 10% by weight in terms of metal was continuously added dropwise such that iron(II) hydroxide equivalent to 4.5 mol % of iron was precipitated on a surface of nickel hydroxide, and a 25% by mass sodium hydroxide aqueous solution was also added dropwise so as to maintain a pH of 11.00±0.05 (measured value at 75° C.).

As a result, a slurry of a nickel-aluminum hydroxide coated with iron hydroxide was obtained. Subsequently, the obtained slurry was dehydrated, washed with an alkali and washed with water, then dried at 110° C. for 10 hours, and then caused to pass through a 100 mesh sieve to obtain 1 kg of an intermediate compound in which a surface of the nickel-aluminum hydroxide was coated with iron hydroxide.

### <Preparation of Positive Electrode Active Material>

1.38 g of the obtained intermediate compound and 0.65 g of a lithium compound (LiOH·H₂O) were dispersed in ethanol in a mortar and mixed. Thereafter, the resulting mixture was filled in a JIS standard platinum crucible. The mixture filled in the platinum crucible was heated in air at a temperature-rising rate of 10° C./min and fired at 750° C. for 10 hours using a firing furnace, and then the obtained powder was left to stand until the temperature of the powder reached room temperature (25° C.) to obtain a positive electrode active material of Comparative Example 2 having a chemical composition presented in Table 1.

### Example 3

### <Preparation of Positive Electrode Active Material>

A positive electrode active material of Example 3 having a chemical composition presented in Table 2 was obtained in a similar manner to Example 1 except that the chemical compositions of nickel, aluminum, and iron were adjusted to values presented in Table 2. In Table 2, “-” means that the element is not contained.

### Comparative Example 3

### <Preparation of Positive Electrode Active Material>

A positive electrode active material of Comparative Example 3 having a chemical composition presented in Table 2 was obtained in a similar manner to Example 1 except that the heat treatment conditions were adjusted as presented in Table 2.

### Comparative Example 4

### <Preparation of Positive Electrode Active Material>

A positive electrode active material of Comparative Example 4 having a chemical composition presented in Table 2 was obtained in a similar manner to Example 1 except that the heat treatment conditions were adjusted as presented in Table 2.

### Comparative Example 5

### <Preparation of Nickel-Cobalt-Aluminum Coprecipitated Hydroxide>

In a 5 L sealed flat-bottom beaker equipped with a stirrer including a stirring blade having a blade diameter of 7 cm and an overflow tube having an inner diameter of 5 mm at a top, 3 L of water was put, and the water was heated to 50° C. Thereafter, 150 mL of 25% by mass aqueous ammonia was added thereto, and a sulfuric acid aqueous solution or a sodium hydroxide aqueous solution was added thereto such that a pH was 11.00 (measured value at 50° C.).

While the liquid temperature in the beaker was maintained at 50° C. and the mixture in the beaker was stirred at a speed of 600 rpm, a solution adjusted so as to contain nickel sulfate, cobalt sulfate, and aluminum sulfate at a molar ratio (Ni:Co:Al=91.0:4.5:4.5) at a concentration of 10% by weight in terms of metal was continuously added thereto at a flow rate of 300 mL/h, and 25% by mass aqueous ammonia was further added thereto at a flow rate of 30 mL/h. In addition, a 25% by mass sodium hydroxide aqueous solution was continuously added thereto so as to keep the pH of the reaction liquid in the beaker at 11.00±0.05 (measured value at 50° C.).

While a liquid property of the reaction liquid was controlled, a slurry concentration apparatus was connected and a solid-liquid separation operation was continuously performed. Only a filtrate was discharged to the outside of the system, and an operation of increasing a slurry concentration was performed in parallel. The slurry after completion of the reaction was dehydrated and washed with water to obtain a nickel-cobalt-aluminum coprecipitated hydroxide. The slurry after completion of the reaction was dehydrated, washed with an alkali and washed with water, then dried at 110° C. for 10 hours, and then caused to pass through a 100 mesh sieve to obtain a nickel-cobalt-aluminum coprecipitated hydroxide (intermediate compound).

### <Preparation of Positive Electrode Active Material>

1.36 g of the obtained intermediate compound and 0.64 g of a lithium compound (LiOH·H₂O) were dispersed in ethanol in a mortar and mixed. Thereafter, the resulting mixture was filled in a JIS standard platinum crucible. The mixture filled in the platinum crucible was heated in air at a temperature-rising rate of 10° C./min and fired at 750° C. for 10 hours using a firing furnace, and then the obtained powder was left to stand until the temperature of the powder reached room temperature (25° C.) to obtain a positive electrode active material of Comparative Example 5 having a chemical composition presented in Table 2.

### (Analysis)

Chemical compositions of the positive electrode active materials obtained in Examples and Comparative Examples were analyzed by an ICP emission spectrophotometer (trade name: Agilent 5110 VDV, manufactured by Agilent Technologies, Inc.), and results thereof are presented in Tables 1 and 2.

X-ray diffraction (XRD) patterns of the positive electrode active materials obtained in Examples and Comparative Examples were measured with a powder X-ray diffractometer (trade name: SmartLab, manufactured by Rigaku Corporation). Cu (copper) was used as a target to be irradiated with an electron beam, and a Kα ray was used as a characteristic X-ray. A lattice constant was determined by a least square method using each index of each of the obtained XRD patterns and a plane spacing thereof. In addition, the integrated intensity ratio (I₁/I₂) was determined by analyzing the obtained XRD patterns.

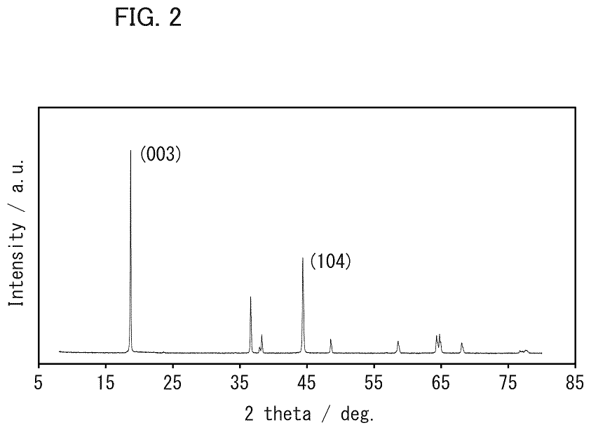

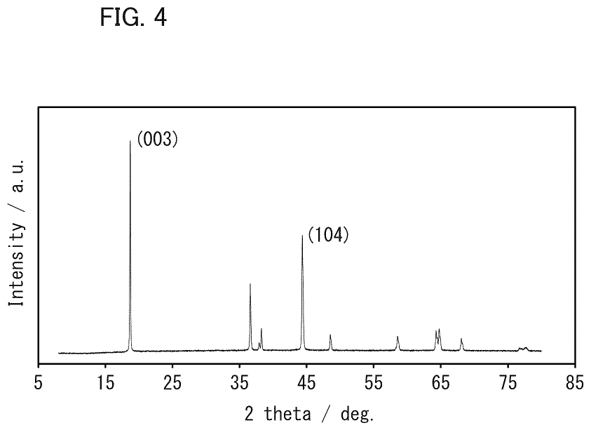

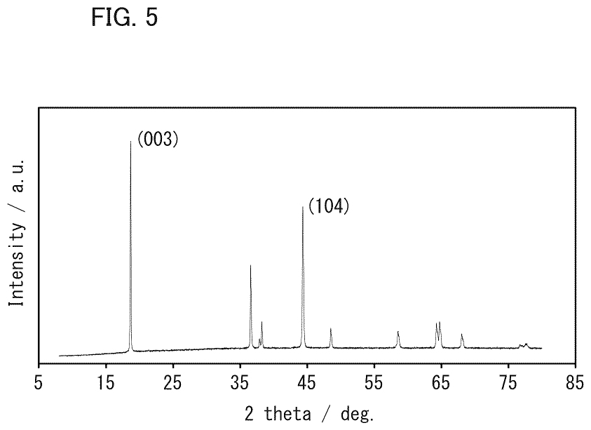

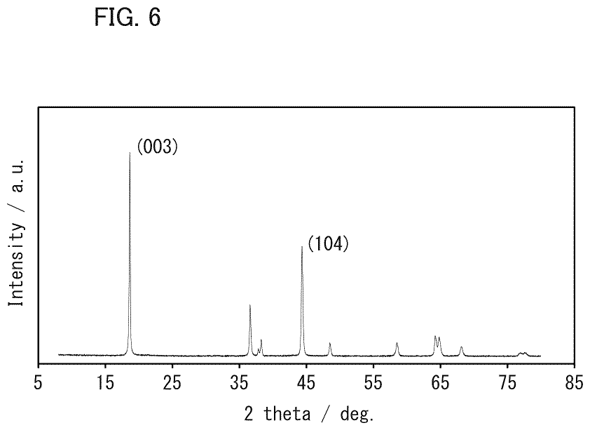

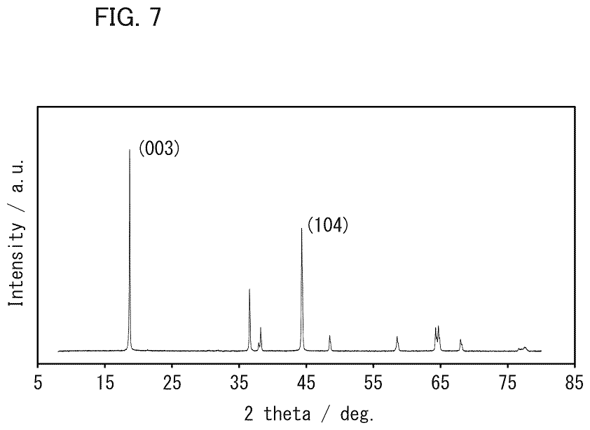

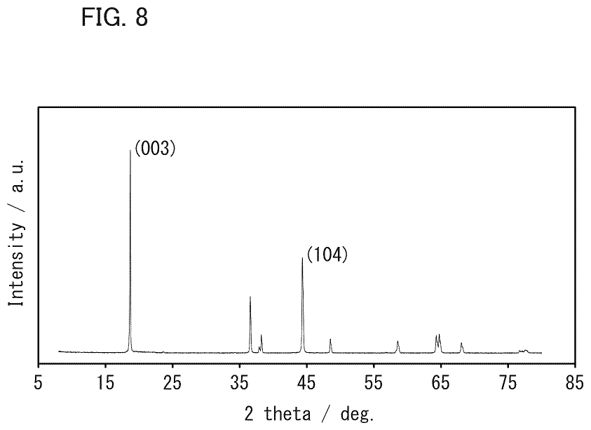

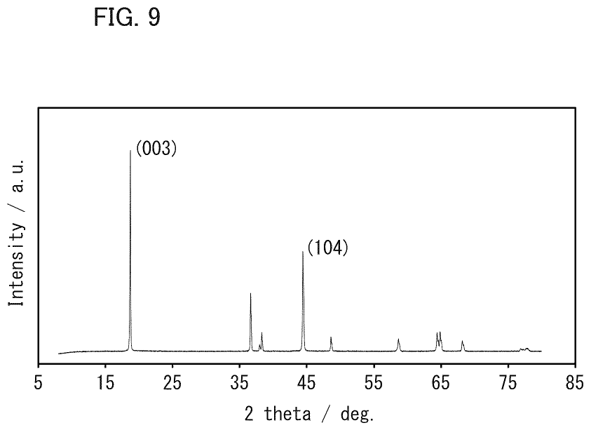

The XRD patterns are illustrated in FIGS. 2 to 9, and a lattice constant value, the integrated intensity ratio (I₁/I₂), and presence or absence of diffraction peak are presented in Tables 1 and 2.

An average particle size (D50) of each of the positive electrode active materials obtained in Examples and Comparative Examples was measured using a laser diffraction particle size distribution analyzer (LS 13 320 manufactured by BECKMAN COULTER). Results thereof are presented in Tables 1 and 2. In Tables, “-” means that the average particle size was not measured.

Results obtained by analyzing compositions of surface layers of the positive electrode active materials obtained in Examples and Comparative Examples by quantitative analysis with an X-ray photoelectron spectroscopy (XPS) analyzer (trade name: K-Alpha⁺, manufactured by Thermo Fisher Scientific) are presented in Tables 1 and 2. Note that measurement conditions of the XPS measurement are described below.

### <<XPS Measurement Conditions>>

Model used: manufactured by Thermo Fisher Scientific,
K-Alpha⁺ (trade name)
Irradiation X-ray: single crystal spectroscopic Alkα (12 keV, 72 W)
X-ray spot diameter: 400 μm
Neutralization electron gun: used
Reference spectrum: C—C, C—H 284.6 eV
Detection depth: 6 to 7 nm

TABLE 1

| | | | Example | Example | Comparative | Comparative |
|---|---|---|---|---|---|---|
| | | | 1 | 2 | Example 1 | Example 2 |
| Positive | Chemical | Li | 0.99 | 1.00 | 1.00 | 1.00 |
| electrode | composition | Ni | 0.92 | 0.91 | 0.88 | 0.87 |
| active | (Molar ratio) | Al | 0.047 | 0.047 | 0.042 | 0.045 |
| material | | Fe | 0.045 | 0.042 | 0.044 | 0.044 |
| | | Co | — | — | — | — |
| | Fe/Ni ratio | Entire particle | 0.049 | 0.046 | 0.05 | 0.051 |
| | | Outer layer | 0.054 | 0.071 | 0.054 | 0.048 |
| | | Outer layer/ | 1.11 | 1.56 | 1.08 | 0.94 |
| | | entire particle | | | | |
| | Heat treatment conditions | | 750° C. 10 h | 750° C. 10 h | 750° C. 10 h | 750° C. 10 h |
| | Lattice | a(Å) | 2.87711(7) | 2.87692(7) | 2.87684(8) | 2.87679(10) |
| | constant | c(Å) | 14.2309(4) | 14.2270(4) | 14.2321(5) | 14.2344(6) |
| | Integrated intensity ratio (I₁/I₂) | | 1.25 | 1.23 | 1.06 | 0.85 |
| | Average particle size(μm) D50 | | 11.63 | 8.45 | 7.09 | 13.04 |
| Battery | Discharge | 0.05 C. | 214 | 222 | 216 | 210 |
| charac- | capacity | | | | | |
| teristics | (mAh/g) | 5 C. | 174 | 175 | 156 | 164 |

| | | | | |
|---|---|---|---|---|
| Average discharge | 3.802 | 3.768 | 3.702 | 3.747 |
| voltage(V) 5 C. | | | | |

TABLE 2

| | | | Example | Comparative | Comparative | Comparative |
|---|---|---|---|---|---|---|
| | | | 3 | Example 3 | Example 4 | Example 5 |
| Positive | Chemical | Li | 1.00 | 1.00 | 0.98 | 1.00 |
| electrode | composition | Ni | 0.80 | 0.91 | 0.92 | 0.91 |
| active | (Molar ratio) | Al | 0.084 | 0.047 | 0.039 | 0.045 |
| material | | Fe | 0.120 | 0.045 | 0.046 | — |
| | | Co | — | — | — | 0.045 |
| | Fe/Ni ratio | Entire particle | 0.150 | 0.049 | 0.050 | — |
| | | Outer layer | 0.112 | 0.045 | 0.000 | — |
| | | Outer layer/ | 0.75 | 0.92 | 0.00 | — |
| | | entire particle | | | | |
| | Heat treatment conditions | | 750° C. 10 h | 750° C. 5 h | 750° C. 20 h | — |
| | Lattice | a(Å) | 2.87390(14) | 2.88016(6) | 2.87702(4) | 2.86988(7) |
| | constant | c(Å) | 14.2512(9) | 14.2338(4) | 14.2280(3) | 14.1948(4) |
| | Integrated intensity ratio (I₁/I₂) | | 1.20 | 1.14 | 1.27 | 1.25 |
| | Average particle size(μm) D50 | | 10.46 | 9.12 | 13.81 | — |
| Battery | Discharge | 0.05 C. | 164 | 160 | 198 | 215 |
| charac- | capacity | | | | | |
| teristics | (mAh/g) | 5 C. | 106 | 101 | 140 | 167 |

| | | | | |
|---|---|---|---|---|
| Average discharge | 3.725 | 3.748 | 3.671 | 3.751 |
| voltage(V) 5 C. | | | | |

From the XRD patterns illustrated in FIGS. 2, 3, and 6, it was confirmed that the positive electrode active materials of Examples 1, 2, and 3 each have an integrated intensity ratio (I₁/I₂) of 1.15 or more and 1.35 or less.

### <Preparation of Lithium-Ion Secondary Battery>

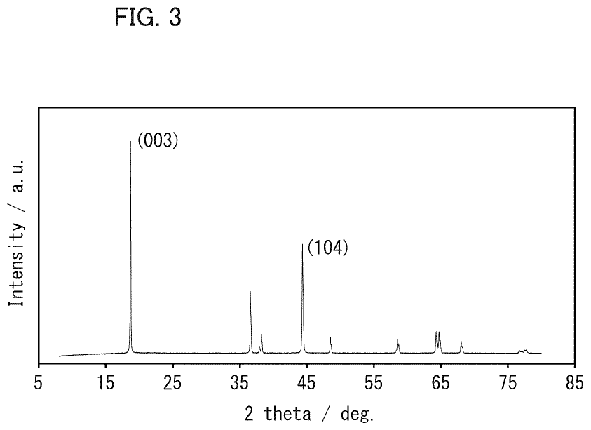

To each of the positive electrode active materials obtained in Examples and Comparative Examples, acetylene black (AB) as a conductive agent, and polyvinylidene fluoride (PVDF) as a binder were blended at a weight ratio of 8:1:1 by using N-methyl-2-pyrrolidone (NMP) as a solvent to prepare a slurry. Thereafter, an aluminum foil having a thickness of 15 μm was coated with the slurry and was dried to prepare a positive electrode having a diameter of 14 φ. A coating area density was set to 4.5 mg/cm², and a volume density was set to 2.3 g/cm³. With respect to the positive electrode, a lithium metal having a thickness of 200 μm and a diameter of 16 φ was used as a counter electrode, and a polyethylene microporous film having a thickness of 20 μm and a diameter of 18 φ was used as a separator. A 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3) was used as an electrolytic solution, and a lithium-ion secondary battery (2032 coin-type cell) having the structure illustrated in FIG. 3 was prepared. The battery was prepared according to a known cell configuration and assembly method.

### <Charge and Discharge Test>

Each of the prepared lithium-ion secondary batteries was subjected to a charge and discharge test at a constant current at a rate of 0.05 C or 5 C (1 C: 200 mA/g) at a cutoff potential of 4.3 V to 2.5 V under a temperature condition of 25° C. to evaluate an initial discharge capacity. The charge and discharge test was started from charge. Results thereof are presented in Tables 1 and 2.

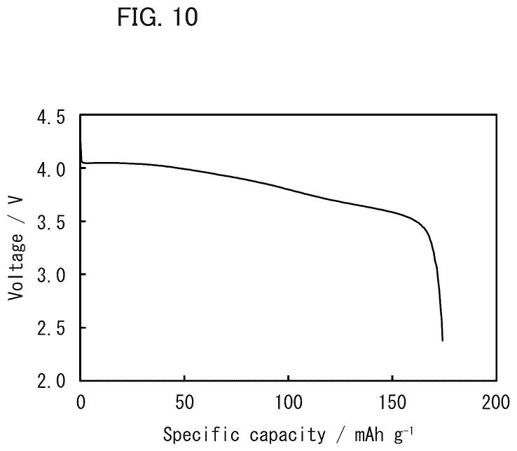

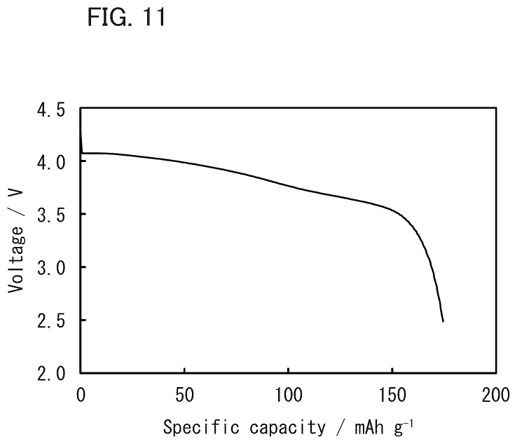

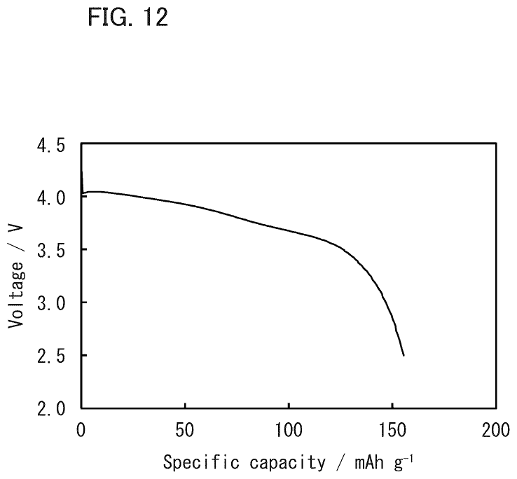

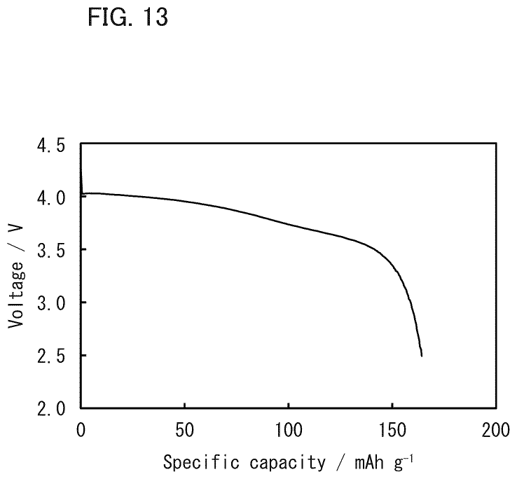

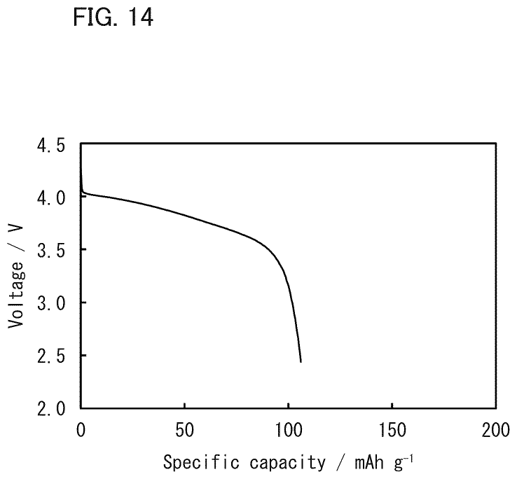

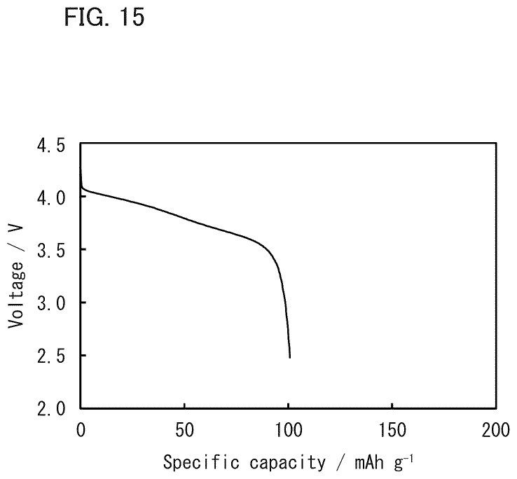

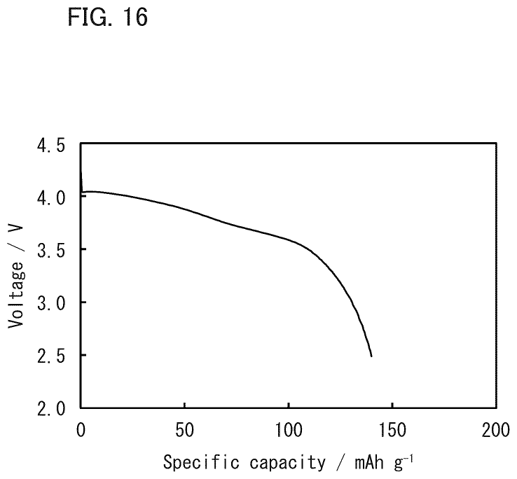

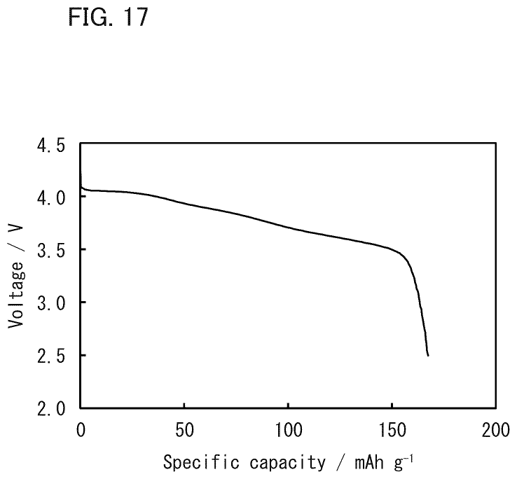

Discharge curves of the lithium-ion secondary batteries of Examples and Comparative Examples at 5 C are illustrated in FIGS. 10 to 17, respectively.

From the discharge curves of FIGS. 10 to 17, it was confirmed that discharge capacities and average discharge voltages of the lithium-ion secondary batteries of Examples 1 and 2 were better than those of the lithium-ion secondary batteries of Comparative Examples 1 and 2. In addition, in general, it is known that a discharge capacity can be increased as the content of nickel in a positive electrode active material increases. It was confirmed that a discharge capacity of the lithium-ion secondary battery of Example 3 was better than that of the lithium-ion secondary battery of Comparative Example 3 although the content of nickel in the lithium-ion secondary battery of Example 3 was smaller.

From the above results, it was found that the present invention could provide a lithium-ion secondary battery capable of further increasing a discharge capacity.

What is claimed is:

1. A positive electrode active material for a lithium-ion secondary battery, comprising a lithium transition metal composite oxide as a main component, wherein
the lithium transition metal composite oxide is in a form of a particle having an outer layer on a surface thereof,
the lithium transition metal composite oxide is represented by the following formula (1): 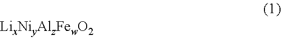
(In formula (1), x, y, z, and w are in ranges of 0.95≤x≤1.05, 0.78≤y≤0.95, 0.01≤z≤0.15, and 0.01≤w≤0.15, respectively, and x+y+z+w=2 is satisfied.),
a ratio between a ratio of the number of atoms of Fe to the number of atoms of Ni in the outer layer and a ratio of the number of atoms of Fe to the number of atoms of Ni in the entire particle is 0.7 or more and 1.7 or less, and
a ratio (I₁/I₂) of an integrated intensity (I₁) of a diffraction peak of a 003 plane to an integrated intensity (I₂) of a diffraction peak of a 104 plane in a space group R-3m measured by X-ray diffraction is 1.15 or more and 1.35 or less.

2. The positive electrode active material for a lithium-ion secondary battery according to claim 1, wherein among lattice constants of the lithium transition metal composite oxide in the space group R-3m, an a-axis length is 2.860 Å to 2.890 Å and a c-axis length is 14.18 Å to 14.28 Å.

3. The positive electrode active material for a lithium-ion secondary battery according to claim 1, wherein particles of the lithium transition metal composite oxide have an average particle size of 2 to 30 μm.

4. A lithium-ion secondary battery comprising: a positive electrode; a negative electrode; and an electrolyte, wherein the positive electrode contains the positive electrode active material for a lithium-ion secondary battery according to claim 1.
